(19) United States
(12) Patent Application Publication
(10) Pub. No.: US 2002/0108280 A1
(43) Pub. Date: Aug. 15, 2002

(54) Illuminated coin display

(76) Inventor: Juan Fernandez, Ridgefield Park, NJ (US)

Correspondence Address: KILPATRICK STOCKTON LLP, 607 14TH STREET, N.W., SUITE 900, WASHINGTON, DC, 20005, US

(21) Appl. No.: 09/781,555

(22) Filed: Feb. 13, 2001

(51) Int. Cl. G09F 3/00

(52) U.S. Cl. 40/323

(57) ABSTRACT

A display unit is specially designed to mount metal coins or the like for display purpose. The unit includes a transparent plate having holes made to fit the coins or the like and hold them in place securely. Electric powered light sources are positioned around the periphery of the transparent plate. The light sources are covered, except allowing light to enter the transparent edges of the plate. The light illuminates the surface of the coins after passing through the surfaces around the coin holes in the plate. The housing of the unit can be configured with a base to allow it to rest on a level surface such as on a table top. The housing can also be configured to allow it to be hung on the wall.

### BACKGROUND OF INVENTION

1. Field of Invention

The present invention relates generally to illuminated displays. In particular, the preferred embodiments of the present invention provide an illuminated coin or the like display.

2. Background of the Invention

Typical coin holders that are commercially available are not illuminated by self-contained light sources. As a result, they must be viewed in an illuminated environment and the visual effect of the coins is unattractive.

There remains a need to improve upon displays for coins and the like and to enhance the visual attractiveness of the coins and the like within such a display.

### SUMMARY OF THE INVENTION

This preferred embodiments of the present invention provide a coin or the like display having a self-contained light source to enhance the visual effect of the coins or the like displayed.

In accordance with one illustrative embodiment of the present invention, a device for holding coins in display includes: a housing having a base; a transparent plate with holes to fit the coins; a liner sheet; a power source (e.g., batteries or the like); and at least one illuminator (e.g., incandescent lights or the like) operated via the power source. Preferably, an electric switch is provided to enable the power source to be connected and disconnected as desired. Preferably, the electronic power source includes an electric power connector socket and a set of one or more batteries.

Preferably, the housing is designed so as to rest upon a level surface such as a tabletop. Preferably, the holes in the transparent plate are configured to hold the edges of coins to be displayed. Preferably, recesses are cut into the peripheral edges of the transparent plate to embrace a number of lights (e.g., incandescent lights) so that they are situated in a desired position. Preferably, the lights are mounted in such a way that allow as much light as possible to enter into the transparent media of the plate (e.g., with the transparent plate operating as a wave-guide).

Preferably, the liner sheet has ornamentation and/or indicia and/or a pattern (e.g., printed or otherwise formed thereon) that is visible through the transparent plate. Preferably, the liner is sandwiched between the transparent plate and the housing.

Preferably, a cover frame is mounted onto the housing to cover the lights, wiring extending to the lights from the power source and the peripheral edges of the transparent plate. The cover frame preferably also helps to prevent light beams from the incandescent lights from going outward towards the eyes of an individual observing the coins on display in the device.

Preferably, the housing of the device includes an ON/OFF electric power switch and an electric socket for connection to an external power source. Preferably, the base also includes a mounting arrangement for a set of batteries. The batteries thus preferably provide electric power to the incandescent lights in the absence of connection to external electric power source (e.g., via an electric chord having a standard two or three prong plug).

Preferably, the base has a central cavity and a base plate is used to cover the cavity of the base of the housing. Preferably, a battery mount is formed within the base plate. The battery mount preferably includes a recess sized to hold batteries and a battery sized to cover an opening to said recess. The battery door allowing the batteries to be changed without dismantling the housing of the unit.

The above and other features, aspects and various advantages and benefits of the invention will be further appreciated by those in the art with reference to the following detailed description of illustrative preferred embodiments taken together with illustrative drawings of these referred embodiments.

### BRIEF DESCRIPTION OF THE DRAWINGS

A number of preferred embodiments of the present invention are shown by way of example, and not limitation, in the following drawings, in which:

FIG. 1 is a perspective view of the front and back of an illustrative illuminated coin display unit;

FIG. 2 is a side sectional view of the illuminated coin display unit shown in FIG. 1;

FIG. 3 is a front view of the illuminated coin display unit shown in FIG. 1 with the cover frame removed;

FIG. 4 is a front view of another illuminated coin display unit having an octagonal shape;

FIG. 5 is a side view of an illuminated coin display unit designed for hanging on a wall or the like;

FIG. 6 is a partial sectional view of one variation the transparent plate; and

FIG. 7 is a partial sectional view of another variation of the transparent plate and the liner sheet.

### DETAILED DESCRIPTION OF THE PREFERRED EMBODIMENTS

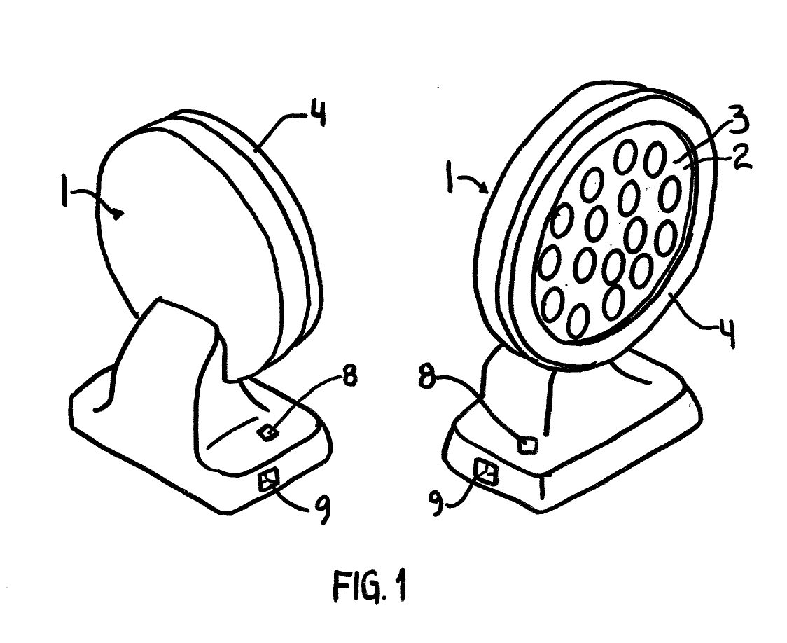

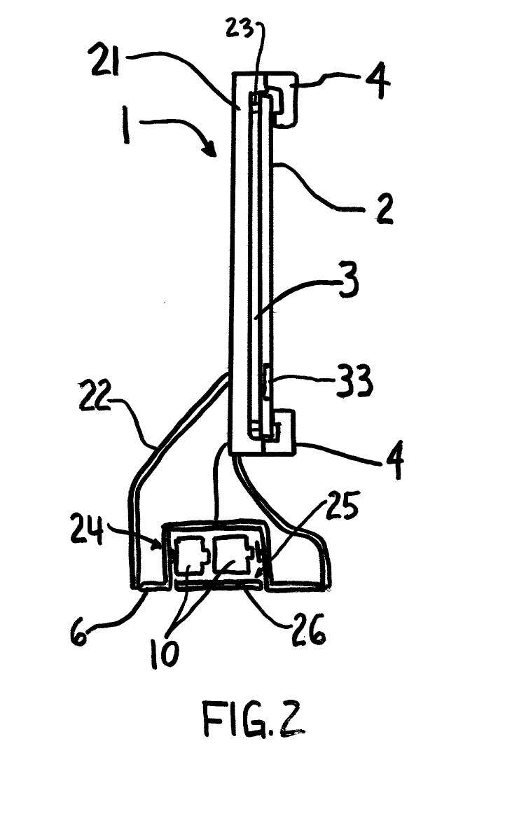

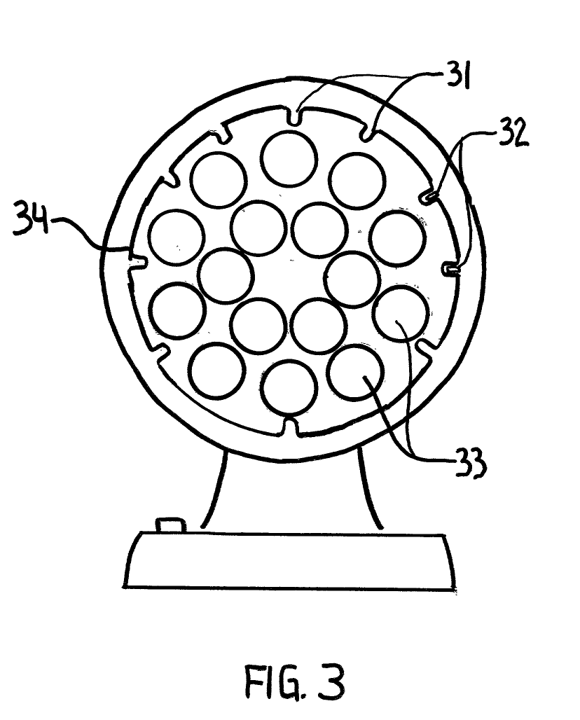

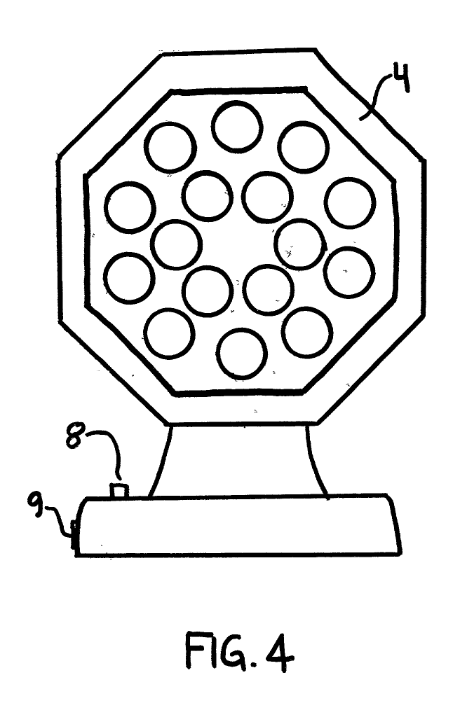

In the preferred embodiment shown in FIGS. 1 and 2, an illuminated coin display unit includes a housing 1, a transparent plate 2 with holes to fit coins, a liner sheet 3, a cover frame 4, a base plate 6, a battery door 26, a set of incandescent lights 32, an electric switch 8, an electric power connector socket 9 and a set of batteries 10.

The housing preferably includes a main body and a base. In some embodiments, the main body and the base can be integrally formed. In other embodiments, the main body and the base are formed by separate members that are connected together. For example, in the illustrated embodiment, the main body includes a main body shell structure 21 and the base includes a base shell structure 22.

The main body shell preferably includes mounting posts 23 onto which the transparent plate 2 is fixed (e.g. via screws or the like). A cover frame 4 is preferably fixed (e.g., by screws, glue or other fixing means) onto the main body shell.

The base shell preferably includes an electric on/off switch 8 and the electric power connector socket 9. The connector socket can, for example, be used to plug in an external electric cord for connection to an external electric power source. The base shell preferably is a substantially hollow structure having a bottom base plate 6. A battery compartment 24 is preferably formed in the base shell to keep the batteries 10 in place. In the preferred embodiment shown, the battery compartment is formed within the base plate and the batteries can be accessed through an opening 25 in the outer surface of the base plate. Preferably, a removable battery door 26 is used to cover this opening into the battery compartment in the base plate.

In a preferred embodiment, the transparent plate 2 is molded in clear plastics of high transparency. In alternative embodiments, the plate can be formed of other light transmitting materials, such as glass, crystal or the like.

Preferably, the peripheral edge of the transparent plate contains a plurality of recesses 31 configured to maintain the illumination sources 32 (e.g., light bulbs such as incandescent light bulbs) in a desired position.

In the illustrated embodiment, a plurality of holes 33 are provided in the transparent plate that are configured for holding respective coins. Preferably, all or substantially all of the external surfaces of the transparent plate (e.g., such surfaces including the inner surface, the peripheral edge, the outer surface and/or the surfaces around holes in the plate) are highly glossy so as to enhance reflecting of light from these surfaces and transmission of light internally within the transparent plate. In this manner, the transparent plate act as a medium for the transmission of light (e.g., acting as a light wave guide). Preferably, the transparent plate in this embodiment is thicker than the width of the coins so that when a coin is placed within a hole on the transparent plate, part of the perimeter 34 of the holes is exposed above the outer surface of the coin, so as to allow light to pass through this the surface that is not obstructed by the peripheral edge of the coin and illuminate the visible outer surface of the coin.

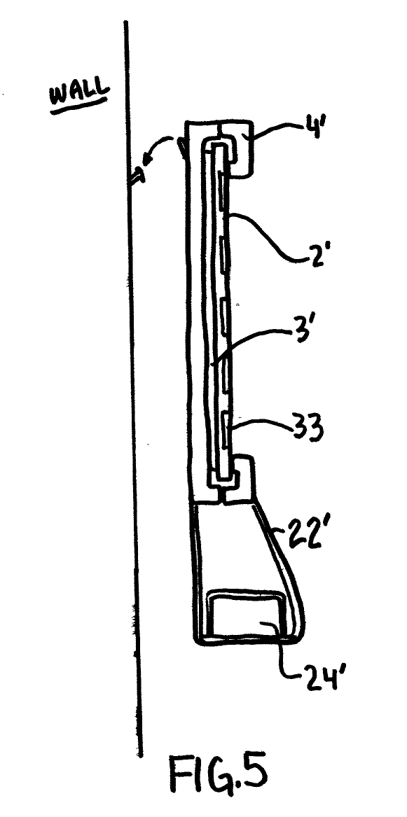

FIG. 5 shows an alternative embodiment that is configured to hang on a wall (e.g. upon a nail, hook or the like as shown or via any known hanging means). It should be understood that the configuration can be varied as appropriate.

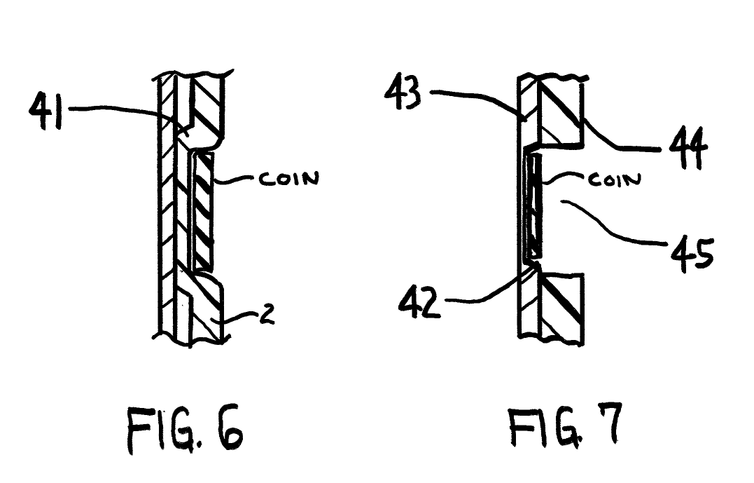

FIG. 6 shows a partial sectional view of one alternative variation of the transparent plate. In this variation, the transparent plate is provided with respective circumferential ridges 41 around the peripheries of each coin hole so as to hold respective coins fitted within the respective holes. In this case, the thickness of the transparent plate can be selected as desired (e.g., made any desired thickness) to achieve good illumination of the coins.

FIG. 7 shows a partial sectional view of another alternative variation of the coin holding structure. In this variation, the coins are held by holes 42 within the liner sheet 43 instead of within holes of the transparent plate 44. However, there are still preferably holes 45 made into the transparent plate for placement of the coins and/or for illumination of the coins.

In some preferred embodiments, the coins displayed are coins having a silver-color outer surface. In this manner, reflectivity may be greater than that of certain bronze-color coins or the like. In more preferred embodiments, the coins are United States quarters. In more preferred embodiments, the coins are United States commemorative state quarters (e.g., those issued starting in 1999). In the latter case, there are preferably fifty holes for receiving respective quarters for each respective state. In the latter case, a liner behind the respective holes preferably includes indicia identifying the respective commemorative coin to be inserted. Preferably, the display is configured such that the quarters are to be placed sequentially in time of commemorative quarter issuance and/or in time of original statehood (e.g., with the earliest at the top left position). For example, the first top-left position can include indicia stating “Delaware, 1999, Dec. 7, 1787.”

While the present invention has been described in conjunction with some preferred embodiments thereof, it should be appreciated by those in the art that various modifications, embodiments, alterations and adaptations may be made by those in the art after reviewing this application without departing from the scope of this invention. For example, in the illustrated embodiments, the coin holes have been formed in a round shape, but it should be understood that the shapes of the holes can be varied as desired so long as they serve the needed functions of the respective embodiment—e.g., so long as they can hold the respective coins and/or illuminate the respective coins. As just another example, the sizes and shapes of the housing, base and/or any other portions of the display device can be selected as desired based on circumstances. As just another example, while the coin holes are preferably sized so as to securely hold the coins without additional mounting means, in other embodiments other mounting means could be used as desired, such as adhesives, clips, covers or the like. As just another example, the embodiments of the present invention can be adapted for use in the display of other items, such as for example: tokens, chips, stamps, spoons, baseball cards or other cards, gems or stones or other items.

What is claimed is:

1. A coin display, comprising:
a) a housing;
b) a substantially transparent plate for transmitting light having a plurality of coin holes;
c) a liner sheet behind said transparent plate; and
d) a display-mounted light source positioned to illuminate the coins on display.

2. The display of claim 1, wherein the plate is made of substantially transparent plastic and with high gloss surfaces to facilitate transmission and reflection of light.

3. The display of claim 1, wherein the transparent plate includes coin holes.

4. The display of claim 3, wherein the coin holes are configured to provide illumination of the coins.

5. The display of claim 4, wherein the coin holes are configured to secure the coins in the display.

6. The display of claim 2, wherein the liner includes coin holes that are configured to secure the coins in the display.

7. The display of claim 1, wherein recesses are made on the peripheral edge of the transparent plate to accommodate light sources and to enable light from these light sources to enter into the transparent media of the plate.

8. The display of claim 7, wherein the light sources that are fitted into the recesses of the transparent plate are incandescent lights.

9. The display of claim 7, wherein the light sources that are fitted into the recesses of the transparent plate are florescent lights.

10. The display of claim 7, wherein the light sources that are fitted into the recesses of the transparent plate are solid-state lights.

11. The display of claim 10, wherein said lights are light-emitting diodes.

12. The display of claim 1, wherein the housing is configured to allow placement of the display on a level surface.

13. The display of claim 1, wherein the housing is configured to allow hanging of the display from a substantially vertical wall surface.

14. The display of claim 1, wherein the housing is configured to allow placement of the display on a level surface and to allow hanging of the display from a substantially vertical wall surface.

15. A method for displaying coins, comprising:
i) providing a coin display, including:
a) a housing;
b) a substantially transparent plate for transmitting light having a plurality of coin holes;
c) a liner sheet behind said transparent plate; and
d) a display-mounted light source positioned to illuminate the coins on display; and
ii) displaying coins within said display.

16. The method of claim 15, wherein said coins are United States quarters.

17. The method of claim 16, wherein said coins are commemorative state quarters and 50 holes are provided for respective commemorative state quarters.
